(19) United States
(12) Patent Application Publication
(10) Pub. No.: US 2006/0139873 A1
(43) Pub. Date: Jun. 29, 2006

(54) Electronic instrument having recording and reproduction device

(76) Inventors: Takahito Tomizawa, Fukui (JP); Hirotoshi Hara, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/316,823

(22) Filed: Dec. 27, 2005

(30) Foreign Application Priority Data
Dec. 28, 2004 (JP) 2004-378524

(51) Int. Cl. G06F 1/16

(52) U.S. Cl. 361/685

(57) ABSTRACT

In order to provide an electronic instrument having a recording and reproduction device mounted on a chassis via buffer members in which number of components forming legs is reduced and the recording and reproduction is protected from shock or vibration, the buffer members are extended to a downside of the chassis. The recording and reproduction device has four legs, which each of the legs has a support shaft extended downward for screw-clamping a buffer member having a shaft hole for mounting. Through-holes for inserting the buffer members are formed in the chassis at points corresponding to the legs respectively, and size of the through-holes allows the buffer members fitting into and allows the buffer members fixing to the chassis respectively due to elastic deformation when the buffer members are screw-clamped to the support shafts.

### BACKGROUND OF THE INVENTION

1. Field of the Invention

The present invention relates to an electronic instrument that may relieve external transmission of unexpected shock or vibration to a recording and reproduction device mounted on a chassis.

2. Related Art

In an electronic instrument having a recording and reproduction device such as disk drive, the recording and reproduction device is mounted on a chassis of a cabinet, and sometimes is not directly screw-clamped to the chassis but mounted via buffer members between them. This is for suppressing influence of shock or vibration applied from the outside of the electronic instrument on the recording and reproduction device. The shock or vibration can be absorbed by the buffer members, and a phenomenon of shut down of the instrument during recording or reproduction can be prevented.

In the case of a typical electronic instrument incorporating the recording and reproduction device, the instrument is in a configuration where legs of the electronic instrument are provided on a bottom of the chassis, and on the other hand, the recording and reproduction device is supported on the chassis via the buffer members. That is, the legs of the electronic instrument and the buffer members for the recording and reproduction device are configured as separated components. Therefore, the number of components is increased compared with a case that the legs and the buffer members are configured by the same component, and the number of assembly is also increased, leading to increase in cost.

While there are various sizes and shapes in a metal chassis for setting the recording and reproduction device, since the chassis is produced through respective steps such as punching and bending, particularly, a large chassis may be deformed by deflection during production. On the other hand, variation in height of the legs may also occur. Therefore, when the electronic instrument is placed on a floor face or a table face, rattle occurs by effects of them.

In an assembly process of the electronic instrument incorporating the recording and reproduction device, assembly is performed in a final step so that unexpected shock or vibration is not applied to the recording and reproduction device and thus damage of the device is prevented. In particular, in the case of assembly of a hard disk susceptible to shock or vibration, the hard disk needs to be assembled in the final step. Therefore, inspection associated with the recording and reproduction device must be performed in another step, or the inspection is performed after the assembly of the electronic instrument is completed. In the inspection of the recording and reproduction device in another step, the same circuit board as a circuit board incorporated in the electronic instrument must be prepared for inspection; and in the case that the inspection is performed after assembly of the electronic instrument is completed, if a problem occurs, the instrument must be decomposed.

“Recording and/or reproduction device” according to JP-A-2000-76836 is a device that may absorb vibration occurring in a device body well, and securely protect a bottom side of a device body. The device is in a configuration where a drawing portion by which a support is formed is provided upwardly protrusively on a mounting base (chassis), and a device body (recording and reproduction device) is supported by the support via a vibration absorber. Thus, vibration in the device body is absorbed by the vibration absorber and therefore is not transmitted to the mounting base. However, this structure is essentially a buffer member for the device body, and does not function as legs for supporting the mounting base (chassis).

“Vibration absorbing device” according to JP2002-349634 is a vibration absorbing device that can prevent delay in data write by attenuating external vibration, and has a body, an elastic displacement portion provided on the body, and a protrusion which is freely displaced by the elastic displacement portion and provided on the body, wherein the elastic displacement portion acts as a damper and can attenuate the external vibration transmitted to the protrusion.

In this way, while the recording and reproduction device that is incorporated in the electronic instrument and mounted on the chassis is supported via the buffer members in the related art, the legs of the electronic instrument to be set on a floor face or a table are separately provided. Therefore, the number of components is increased, and consequently cost of production and assembly is increased, and in many cases, rattle occurs in legs attached to respective corners of the chassis. In particular, when size of the chassis is increased, the chassis may be deformed with punching or bending during production of the chassis, and therefore height at lower end faces of respective legs is not uniform, causing rattle.

### SUMMARY OF THE INVENTION

The present invention is to solve problems as above mentioned, and an object of the invention is to provide an electronic instrument that is configured to use the buffer members for the recording and reproduction device even as the legs of the electronic instrument.

Thus, an electronic instrument according to the invention is configured in which it has a recording and reproduction device mounted on the chassis via the buffer members, wherein the buffer members are extended to a downside of the chassis. According to such a configuration, the same buffer members support the incorporated recording and reproduction device, and simultaneously support a body of the electronic instrument.

The electronic instrument may be in a configuration where the recording and reproduction device has four legs; each of legs has a support shaft extended downward for screw-clamping a buffer member having a shaft hole for mounting; through-holes for inserting the buffer members are formed in the chassis at points corresponding to the legs respectively; and size of the through-holes allows the buffer members fitting into and allows the buffer members fixing to the chassis respectively due to elastic deformation when the buffer members are screw-clamped to the support shafts.

Preferably, a configuration is made, in which a collar having an increased outer diameter is formed at upper end of each buffer member, and fringes of the through-holes in the chassis are contacted to lower faces of the collars respectively. Moreover, it is possible that narrow slots having a width corresponding to thickness of the chassis are formed at a fixed depth in peripheries of the buffer members respectively, and each of the through-holes is formed by an insertion hole through which the buffer member can be freely inserted and a mounting hole continued to the insertion hole and have a fringe to be fitted into the narrow slot of the buffer member.

According to the electronic instrument of the invention, since the buffer members provided between the recording and reproduction device and the chassis not only absorb the shock and vibration applied from the outside, but also are used commonly as both the support members for the recording and reproduction device and the legs of the electronic instrument, and therefore, reduction in number of components has been able to be achieved.

Moreover, even in the case that legs are attached to respective corners of the chassis in addition to the legs combined by the buffer members in an electronic instrument having large width and depth, the legs as the buffer members are protruded slightly long and thereby can be contacted to a floor face in a compressive deformation condition, and therefore rattle in the electronic instrument as a whole has been able to be prevented.

Furthermore, thanks to a structure in which the buffer members are provided between the legs of the recording and reproduction device and the chassis for supporting the device, even if a hard disk particularly susceptible to vibration is assembled, it is possible that the recording and reproduction device and a circuit board are mounted on the chassis in an initial stage of an assembly process, and inspection associated with the recording and reproduction device can be carried out without caring about external vibration. As a result, improvement in efficiency of assembly of the electronic instrument has been achieved.

### BRIEF DESCRIPTION OF THE DRAWING

FIG. 1 is a plane view showing an inside of an electronic instrument according to the invention;

FIG. 2 is a front view showing the inside of the electronic instrument;

FIG. 3 is a side view showing the inside of the electronic instrument;

FIG. 4 is a vertical section view showing a mounting aspect of a buffer member to support a disk drive within the electronic instrument;

FIG. 5A and FIG. 5B are a vertical section view and a bottom view respectively, showing a mounting procedure of a buffer member to support a disk drive within an electronic instrument according to another embodiment of the invention; and

FIG. 6A and FIG. 6B are a vertical section view and a bottom view respectively, showing a mounting condition of the buffer member in FIG. 5A and FIG. 5B.

### DETAILED DESCRIPTION OF PREFERRED EMBODIMENT

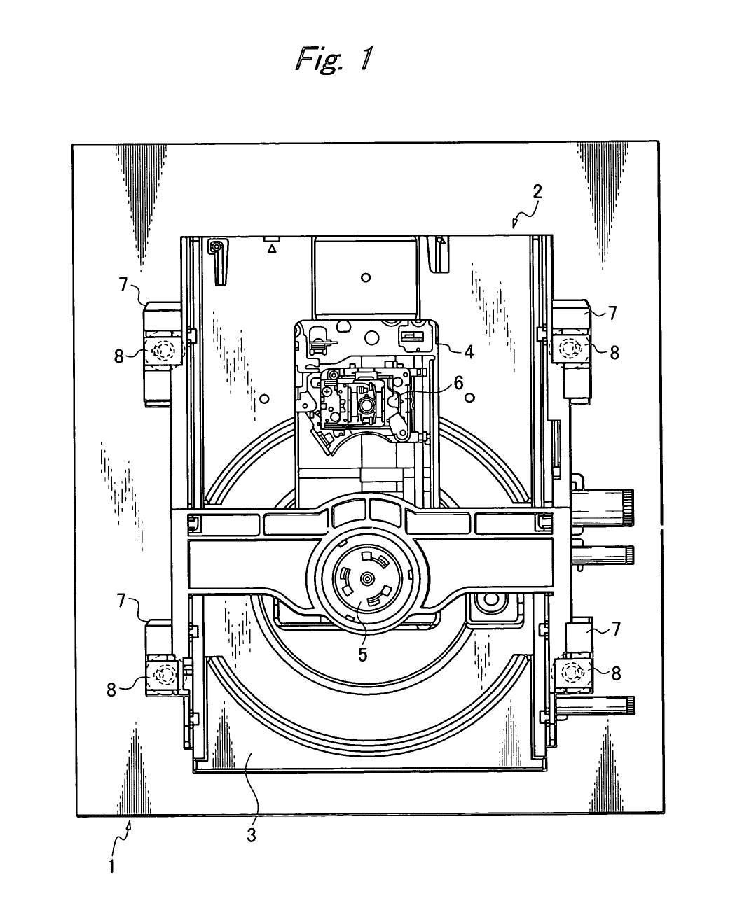

FIG. 1 shows an electronic instrument according to an embodiment of the invention, wherein a disk drive 2 as a recording and reproduction device is disposed in a cabinet 1. The disk drive 2 has a tray 3, and while not shown, a pinion gear driven by a motor is engaged with a rack gear disposed on a lower surface of the tray 3, and the tray 3 is transported reciprocally between a disk exchanging position and a reproduction position by rotation of the motor.

When a disk is set on the tray 3 and then carried into the instrument, a traverse unit 4 is moved up, and the disk is set on a turntable, and then starts to rotate with being held between the turntable and a damper 5. An optical pickup unit 6 starts to move concurrently with rotation start of the device to perform recording or reproduction. When the recording or reproduction is finished, the traverse unit 4 is moved down, and the disk is set on the tray 3 and carried out to the disk exchanging position. A carrying unit for the disk is not limited to the tray 3, and may be a pull-in type carrier, which is provided within the device to pull the disk into the device by inserting part of the disk form an insertion slot

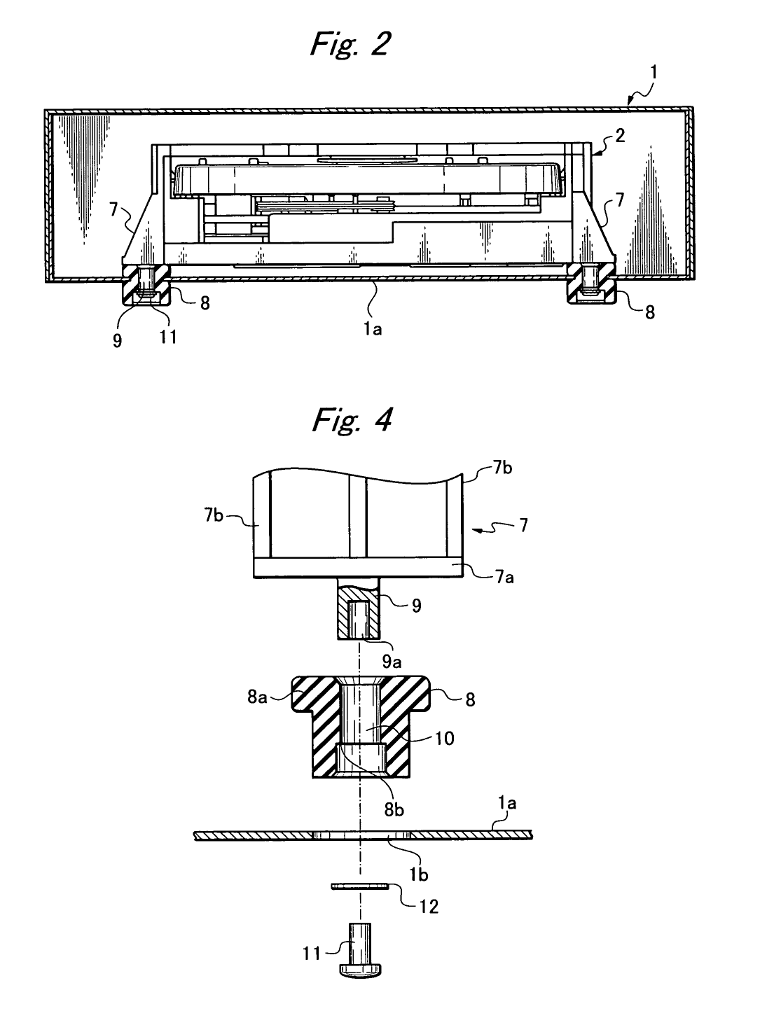

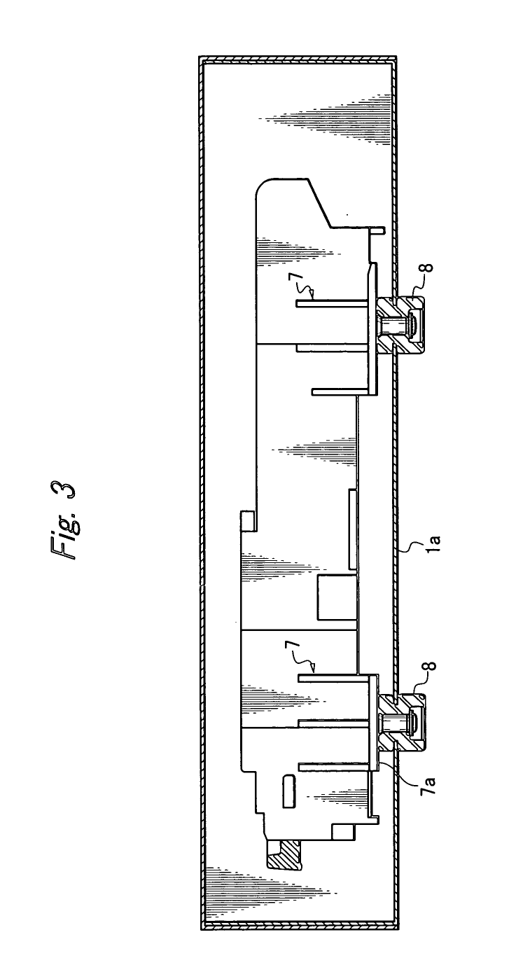

As shown in FIG. 1, the disk drive 2 has four legs 7, 7 . . . at both sides, and buffer members 8 are attached to bottom sides of those legs 7. The disk drive 2 is mourned on a chassis 1a forming a bottom of the cabinet 1 via the buffer members 8, 8 . . . (refer to FIGS. 2 and 3). The buffer members 8 provided on lower sides of the legs 7 of the disc device 2 extend downward through the chassis 1a, and act even as legs of the electronic instrument That is, the buffer members 8 act as supports for the disk drive 2 at upper parts, and act as the legs of the electronic instrument at lower parts with respect to the chassis 1a as a reference, respectively.

As shown in FIG. 4, each leg 7 attached with the buffer member 8 has a bottom plate 7a disposed horizontally and reinforcing plates 7b for reinforcing the bottom p. A support shaft 9 for attaching the buffer member 8 extends downward at the center of a bottom of the bottom plate 7a. A screw hole 9a is formed at a lower end side of the support shat 9 for a screw 11 to screw with for attaching and fixing the buffer member 8. The buffer member 8 is formed from an elastic material such as soft resin or rubber, in which a stepped hole 10 passing through the center is formed, and a collar 8a having an increased outer diameter is formed at an outer upper part. The stepped hole 10 is formed by a step 8b, which is for setting a flat washer 12 when the buffer member 8 is attached.

Through-holes 1b are formed at points corresponding to the legs 7 in the chassis 1a respectively. Size of the through-hole 1b is formed slightly large compared with a diameter of a lower part of the buffer member 8 such that the lower part of the buffer member 8 can be fitted into the through-hole, and also a lower surface of the collar 8a is placed on the chassis 1a in a fringe of the through-hole 1b.

When the disk drive 2 is mounted on the electronic instrument; first the buffer members 8 in which the stepped holes 10 are fitted with the support shafts 9 are fitted into the through-holes 1b in the chassis 1a. The members 8 are fitted into the through-holes until the lower surfaces of the collars 8a are contacted to the fringes of the through-holes 1b of the chassis 1a, and in that condition, the flat washer 12 is set on the step 8b of the stepped hole 10 and then a screw 11 is threaded in the screw hole 9a of the support shaft 9 to fasten the washer. The buffer member 8 formed from the elastic material such as rubber is screw-fastened, thereby the step 8b is pressed and compressed by the flat washer 12 and as a result the outer diameter of the lower part of the buffer member 8 is expanded and fixed to the chassis 1a (refer to FIG. 2 and FIG. 3). While the embodiment is configured where the screw hole 9a is formed in the support shaft 9 and the buffer member 8 is attached using the screw 11 that screws with the screw hole 9a, it is acceptable that a screw part is provided protrusively at a tip of the support shaft 9 and the member 8 is fastened and fixed by a nut to screw with the screw part.

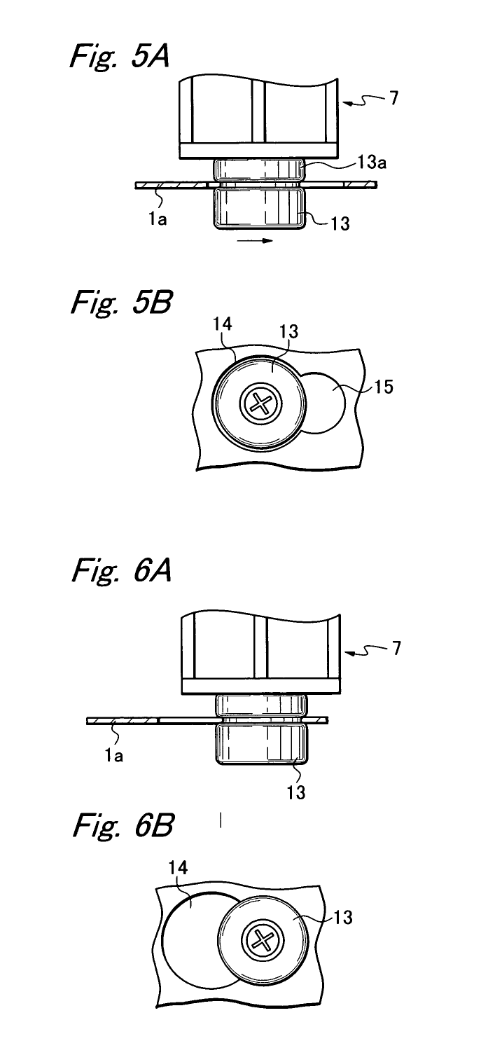

FIG. 5A to FIG. 6B show another embodiment of the invention, wherein a narrow slot 13a having a width corresponding to thickness of the chassis 1a are provided at a fixed depth in the periphery of each buffer member 13. On the other hand, insertion holes 14 through which the buffer members 13 can be freely inserted are formed at the corresponding points in the chassis 1a, and mounting holes 15 continued to the insertion holes 14 are formed respectively, and consequently both form holes in a shape of snowman. An inner diameter of the mounting hole 15 is the same as an outer diameter of a bottom of the narrow slot 13a.

To attach the buffer member 13 to the chassis 1a, first the buffer member 13 is inserted into the insertion hole 14 (refer to FIGS. 5A and 5B), and then an edge of the mounting hole 15 is slid into the narrow slot 13a to move the buffer member 13 into the mounting hole 15. Such movement allows a fringe of the mounting hole 15 to be fitted into the narrow slat 13a, consequently positioning of the disk drive 2 is achieved. Then, screw fastening is carried out similarly as in the first embodiment, thereby the buffer member 13 is compressed and fixed to the mounting hole 15 in the chassis 1a.

In the electronic instrument in which only the disk drive 2 is mounted on the chassis 1a (refer to FIGS. 2 and 3), the four buffer members 8, 8 . . . for supporting the disk drive 2 may be used even as the legs of the electronic instrument, and other legs are not necessary for supporting the electronic instrument. However, in the case of an electronic instrument tit includes a device other than the disk drive and has a chassis 1a having large width and depth, stability of the electronic device is not sufficient only by the four buffer members. Therefore, it will be appreciated that in the case of an electronic device having a large size, legs as separated components may be attached to respective corners of the chassis for supporting a bottom of the electronic instrument together with the legs combined by the buffer members of the invention.

Moreover, the chassis of the electronic instrument having the large size naturally becomes larger, therefore the chassis as a whole is slightly deformed due to punching or partial bending, and thereby lower ends of the legs attached to the corners are not uniform at the same surface. Therefore, rattle may occur even if the instrument is placed on a flat floor face. Even in such a case, since the buffer members are used even as the legs of the electronic instrument according to the invention, the raffle due to the legs attached to the corners can be prevented. Since the buffer members are made of a soft material such as soft resin or rubber, even if the legs are somewhat long, the members may be appropriately compressed and deformed by contacting to the floor face and prevent the rattle.

What is claimed is:

1. An electronic instrument having a recording and reproduction device mounted on a chassis via buffer members, wherein the buffer members are extended to a downside of the chassis.

2. The electronic instrument according to claim 1, wherein the recording and reproduction device has four legs; each of legs has a support shaft extended downward for screw-clamping a buffer member having a shaft hole for mounting; through-holes for inserting the buffer members are formed in the chassis at points corresponding to the legs respectively; and size of the through-holes allows the buffer members fitting into and allows the buffer members fixing to the chassis respectively due to elastic deformation when the buffer members are screw-clamped to the support shafts.

3. The electronic instrument according to claim 2, wherein a collar having an increased outer diameter is formed at upper end of each buffer member, and fringes of the through-holes in the chassis are contacted to lower faces of the collars respectively.

4. The electronic instrument according to claim 2, wherein narrow slots having a width corresponding to thickness of the chassis are formed at a fixed depth in peripheries of the buffer members respectively, and each of the through-holes is formed by an insertion hole through which the buffer member can be freely inserted and a mounting hole continued to the insertion hole and have a fringe to be fitted into the narrow slot of the buffer member.
